(19) United States
(12) Patent Application Publication
(10) Pub. No.: US 2011/0102154 A1
(43) Pub. Date: May 5, 2011

(54) DETECTION OF MOVING OBJECTS

(75) Inventor: Aage Hindhede, Lem St (DK)

(73) Assignee: SMARTER FARMING A/S, Horsens (DK)

(21) Appl. No.: 12/991,316

(22) PCT Filed: Mar. 25, 2009
(86) PCT No.: PCT/DK2009/050068

§ 371 Date: Jan. 3, 2011

(30) Foreign Application Priority Data
May 5, 2008 (DK) PA 2008 00638

(51) Int. Cl. H04Q 5/22

(52) U.S. Cl. 340/10.1

(57) ABSTRACT

The present invention concerns a system for detecting and determining the position of moving objects, where electronic transceiver units communicate with at least two fixed transceiver stations. It is the object of the invention to perform a constant position determination of movable objects within a delimited area. This may be achieved if communication between the fixed transceiver facilities and the electronic transceiver units occurs in an ultra wideband frequency spectrum in a frequency range from 3.10 GHz to 10.6 GHz, wherein communication occurs in the form of transient pulses emitted from the electronic transceiver units, and where position determination is performed by calculating time or phase difference between receptions of a signal at least two transceiver facilities, respectively. By using high frequency wideband communication, it becomes possible to determine the position of the movable objects with very high accuracy.

### BACKGROUND OF THE INVENTION

1. Field of the Invention

The present invention concerns a system for detection and position determination of movable objects, the objects being provided with an electronic transceiver unit which by reception of a first signal emits a second signal, the second signal containing a unique information code related to a movable object, where the electronic transceiver units communicate with at least two fixed transceiver facilities connected with at least one computer.

2. Description of Related Art

The present invention is further related to a method for indicating normal or abnormal behaviour of animals, such as cattle, where the animals carries detector means, which detector means communicate with processor means carried by the animal, and the processor carried by the animal further communicates with a central processor.

US 2007/0008150 disclose a cattle identification system operating across long distances. This publication concerns a computer system that interacts with transceiver stations transmitting to transceiver systems provided in ear tags on cattle. The electronic circuit provided in the ear tag contains a computer with a memory unit containing data concerning the individual animal. In this patent application, various forms of alternative power supply are described, such as use of solar cells and use of vibration power supply. At the same time is described how to reduce the power consumption for a battery in that listening and transmitting is only performed every 5^{th} minute.

In this publication is thus described communication for identifying cattle. On the other hand, this patent application does not disclose any kind of position determination of the cattle.

CA 2,559,421 discloses a cattle management system where the activity of the cattle is primarily detected by means of electronic ear tags such that it is detected each time the cattle is eating and each time the cattle is drinking. In a central database one may therefore get great knowledge about each single animal provided with the electronic ear tags. The patent application does not disclose any position indication of the cattle.

US 2006/0121851 disclose an ultra wideband security system, primarily for use in airports. Each single piece of baggage is provided with a tag containing an ultra wideband security chip which on the basis of ultra wideband signals can respond such that e.g. left baggage in an airport can be identified automatically. Ultra wideband communication takes place in the frequency range 3.10 GHz to 10.6 GHz. The data communication itself is effected by extremely short pulses. The duration of the pulses may be reduced down to 300-600 ps. The system is primarily used for indicating which baggage pieces that e.g. are aboard an airplane at a given time, or for identifying which pieces of baggage that is in a baggage terminal at a given time. An associated computer system may thus in connection with loading baggage into an airplane examine whether all passengers with baggage in the airplane have gone aboard. Correspondingly, it is described that if a baggage piece has been lost, one may communicate via excess points and thereby possibly make the piece of baggage in question respond. Then you are at least informed about the approximate position in a large airport building where a piece of lost baggage is located.

This patent does describe wideband communication, but no actual mentioning of position determination is done.

WO 2006/022548 concerns a system for locating at least one animal in a predetermined area, provided with at least one label which is designed to be attached to or in at least one animal, which label is provided with a transmitter for transmitting an ultra wideband signal, at least one receiver which is placed in or adjacent to the area and which is designed to receive the ultra wideband signal of the transmitter of the at least one label, and a signal processing device which is connected to or integrated with at least one receiver for locating the at least one label on the basis of the ultra wideband signal received by at least one receiver on the basis of for instance, delay time and/or reception angle.

WO 2007/122394 describes a location system comprising a plurality of base units for enabling the locating of a device by means of one or more location signals communicated between the device and the base units and signal processing equipment for: i. determining the location of the device depending on the manner in which the location signal(s) is/are received and ii. deriving calibration data for calibrating the system depending on the manner in which the location signal(s) is/are received.

WO 2009/011641 concerns a method for detecting oestrus behaviour of a milking animal. The milking animal is provided with a sensor means for detecting an activity level of the milking animal. The method comprises the steps of: monitoring an activity level increase of the milking animal by the sensor means; and detecting the oestrus behaviour depending on a set threshold activity level increase, wherein the threshold activity level increase is set to be indicative of oestrus behaviour of the milking animal depending on the time of the day. The invention provides a reliable means for determining when a milking animal is in heat.

WO 2009/011641 was published after the priority date of the pending application.

### SUMMARY OF THE INVENTION

It is the object of the invention to perform a position determination of movable objects within a area.

A further object of the invention is based on tracked position data for moveable objects, for achieving animal or personal welfare.

A third object of the invention is to indicate abnormal behaviour as early as possible.

A further object is to reduce the use of medical products.

A further object is to have access to behaviour and data by an interne connection.

### DESCRIPTION OF THE INVENTION

This may be achieved by a system as specified in the preamble of claim 1 if communication between the fixed transceiver facilities and the electronic transceiver units occurs in an ultra wideband frequency spectrum in a frequency range from 3.10 GHz to 10.6 GHz, wherein communication occurs in the form of transient pulses emitted from the electronic transceiver units, and where position determination is performed by calculating time or phase difference between receptions of a signal at least two transceiver facilities, respectively.

By using high frequency wideband communication, it becomes possible to determine the position of the movable objects with very high accuracy. In principle, positioning may be performed down to fractions of a wavelength for the given frequency by an efficient phase differential measurement, but in practice, where reflection of signal may occur, there may be expected an accuracy possibly corresponding to one or more wavelengths. By this invention, in practice it is possible to determine the position of objects down to a distance of about 10 cm. Such exact position determination is quite sufficient in most cases when speaking about monitoring movable objects within a limited area.

The system may also include handheld transceiver units containing a computer, the computer containing a database with information related to the movable objects, and where the computer on the basis of received signals selects and presents data related to the nearest positioned movable object or objects for a user. As an alternative to the actual position determination, by the invention is also becomes possible to receive a signal from the individual movable object by means of a handheld computer, e.g. a PDA containing the required transmitter/receiver equipment, as soon as you approach it. If the PDA unit contains relevant object data, it thus becomes possible on the PDA to read the information related to the movable object. The communication system located in the movable object contains possibly only one identification code. By only sending one identification code, a request transmitted from the central units to the movable unit may constitute vary short signals such that the individual signal is transmitted and received within very few nanoseconds.

By a possible embodiment of the invention, the movable objects may be provided in ear tags for cattle. Wideband communication may advantageously be used in connection with cattle or other animals in that the applied transmitting power is extremely small compared with other known forms of electronic communication. At the same time, the higher frequency will entail a far greater position accuracy when desiring to determining the position of e.g. the actual location of cattle.

When the invention is used in ear tags for cattle, transceiver stations may be provided in a stable. By providing a number of transceiver stations in a stable it becomes possible to completely monitor the location of the cattle, for example in a large loose-housing stable. As the actual position of each single piece of cattle becomes available, the behaviour of the animals may be remotely monitored. Thus it becomes possible to identify single animals that possibly seek away from the herd, which may indicate abnormal behaviour.

By an alternative use of the invention, transceiver stations may be placed in a field. Hereby it becomes possible to perform exactly the same position monitoring of a cattle herd as if it goes on a field. In principle, the size of the field is rather uncritical, but by large fields, e.g. fields abroad, e.g. in USA, where cattle goes loose for long periods of time, it may be envisaged to place a number of transceiver stations in each single field such that the entire field is covered, even if e.g. more than 1000 pieces of cattle are present on the field.

In a preferred embodiment of the invention, the computer system is used for performing a position detection of the movable objects by means of the transceiver facilities. Hereby it becomes possible to continuously update a computer with the actual positions of the individuals of cattle. A computer may thus be able to determine whether each single piece of cattle has approached the drinking trough or whether each single piece of cattle has used enough time at an eating trough. Also, one may indicate the position of each single piece of cattle in relation to e.g. the rest of the herd such that abnormal behaviour is indicated. Based on the fact that a computer system knows data of the individual cattle such that expected heat period is known, a deviating behaviour may possibly indicate that the expected heat period has commenced.

The system may advantageously be used for tracking each single movable object. By means of the computer system it may be possible to perform a search for each single piece of cattle, whether in the stable or in the field. On large fields, each single piece of cattle may thus be searched very quickly even in case of cattle located far away from the stable or other service function in connection with the cattle farming. On large open fields it will therefore be a good idea to ensure continuously that each individual piece of cattle at least to a limited extent moves around in order hereby to indicate that the animal is sound and healthy.

By the system it will be possible to perform tracking of abnormal behaviour of cattle. Abnormal behaviour will normally give rise to a changed movement pattern which thus may be determined automatically via a computer system, and the piece of cattle in question may rapidly be identified, and possible veterinary treatment may be commenced rapidly.

Determination of position may advantageously be performed in three different directions where both position and height are determined. By determining height at the same time, it becomes possible to measure whether cattle, for example, lies down at night or whether cattle is standing up throughout the night. Similarly, it may automatically be determined whether lying animals remain lying on the field or in the stable at times where the greater part of the animals rise up. Hereby, identification of illness may also be achieved.

The system may hereby be used for tracking leaping. Hereby may be achieved identification of the piece of cattle performing leaps which may indicate commencing heat/rut.

The system may transmit and receive pulses at different time intervals. Hereby may be achieved that e.g. a certain time of the day, e.g. at night, is chosen for transmitting to the individual movable objects at longer time intervals than at the daytime. Correspondingly, by a differentiated time interval it becomes possible to monitor animals which in principle are unstable far more frequently than animals that normally behave very calmly. A standard time interval may be a couple of seconds between each detection, but e.g. at night the intervals may be reduced to e.g. once every 5^{th} minute. For example, it also becomes possible to communicate with calm animals just once in a minute. A system using ultra wideband may in principle communicate several times by each millisecond, but particularly by monitoring cattle monitoring once per second may be more than sufficient, and in practice a less frequent monitoring will possibly be perfectly applicable. By reducing the number of pulses to be transmitted, the battery service life may be increased in the movable objects such that a battery service life far beyond the expected lifetime of a piece of cattle may be attained. A typical battery service life by signal transmission once per second will typically be five years. If the number of signals is substantially reduced, the battery service life may probably be increased; however, since the batteries also are self-discharging, it is doubtful whether the battery service life can be prolonged significantly beyond five years.

The system can comprise at least one camera, which camera is carried by a 3D servo system, which servo system is controlled from the system, which system direct one or more cameras in the direction of a selected moving object. Hereby a farmer can watch one or more animals in a stable if abnormal behaviour of an animal is detected. This is important if the farmer is analysing the animals from a location far from the stable. The system can be designed so that a farmer can use a mobile phone for analysing his animals.

The system can be further modified by letting the animal carry at least an accelerometer for detecting movement of the animal, which system comprises at least a short-range radio communication system for transmitting data from the first processor to the second central processor.

By using an accelerometer placed at an animal, this accelerometer can detect the behaviour of the animal. The accelerometer can detect all the movements of the animal when walking around and also if the animal is laying down for resting or raising from the sleeping position, all this information will be available from an accelerometer. The measured data from the accelerometer can be stored in a computer system which computer system also can be carried by the animal. The computer system carried by the animal can be connected to communication systems so that data that has been recorded in the computer system can be transmitted to a central computer system where data can be stored for more permanent storage. In this way, only a limited storage capacity is necessary at the animal. By the computer system, it is possible to indicate normal or abnormal behaviour of an animal. If the processor indicates abnormal behaviour of the animal in the received signals from the detector, the communication system can be coded to immediately transmit received data to the central processing system. This central processing system can then perform an analysis of the received data and also data already stored in the system. The central system can then by comparing other abnormal behaviour situations already stored in the computer system analyse and maybe find the reason for the abnormal behaviour. The computer system can as soon as abnormal behaviour is indicated contact the person responsible for the animals. In this way farmers can analyse the received data and go directly out in the field or maybe into the stable to personally check the animal themselves.

The short-range radio communications system can communicate according to communication protocol, which communication protocol can operate in relation to a standard known as ZigBee. A well-known communication form is the ZigBee communication standard. By a ZigBee communication standard, communication can only be performed in a very limited distance. The ZigBee is designed so that all signals transmitted are received at all ZigBee receivers inside a range of communication and the data can be further transmitted from one ZigBee transmit receiver to another. In that way, data from one animal can be transmitted to another animal and from there further to a number of animals towards a ZigBee receiver may be placed in a stable roof or at the wall or placed on a post in the field. Data can be transmitted relatively fast in that way even in case of relatively long distances. The only problem in using the ZigBee is that only relatively short messages can be transmitted. By coding the data before transmitting, it should be possible to reduce the size of data so much that communication by ZigBee is possible.

In an alternative embodiment of the invention the short-range radio communications system can communicate in the ultra wideband frequency spectrum, which communication can be performed in a protocol for coding the data which has to be transmitted. Short-range radio communication can also be performed in the ultra wideband frequency spectrum. In this ultra wideband frequency spectrum, it is possible to transmit very large data packages. By ultra wideband communication, it is possible to communicate with each individual animal. In this way, it is possible for the computer system carried by the animal to be in touch with the central processor immediately. In fact, the central computer system could be in touch with each animal even in a large farm where hundreds of animals are placed in a stable or in a field, each computer system carried by the animals can communicate several times per minutes. By using ultra wideband frequency spectrum communication, it is also possible to use received signals from animals for position detection of an animal. The ultra wideband communication makes it possible to position the animals one by one, and then perform a registration of the position of the animal. A further description of position detection of animals is described in the non-published Danish patent application PA 2008 00638 filed by the same applicant.

The system can comprise at least temperature and/or pulse measurements, where the measured values are transmitted to the first processor, which first processors store measured values in a storage medium. The communication system can communicate medical indicators such as temperature or pulse into the local processor carried by the animal and if all values are normal no activities are performed but data are stored. If pulse or temperature is deviating from normal the data can be transmitted immediately.

The data can be stored in a first event log, which event log is part of the storage related to the first processor. By placing a standard event log in the computer system carried by the animal, this event log could be a local copy of new data where each animal carries a standard event log. The event log could comprise a time stamp for movement of the animal and an indication of change in pulse or temperature could also be standard data in an event log.

The data which is stored in the first event log can be transmitted towards the second central processor by short-range radio communication, in which second central processor a second event log for each animal can be updated. It is hereby achieved that the event log carried by the animal can be copied into a central event log so that the central processor knows the history of each of the animals which is surveyed by the system.

The system can be used for tracking abnormal behaviour of animals. By analysing the event log locally at the animal or the event log in the system, it is possible to indicate abnormal behaviour of e.g. cattle.

Acceleration determination can be performed in three different directions and such that horizontal as well as vertical accelerations are determined. By using a very small integrated accelerometer, it is possible in quite a simple manner to detect acceleration or at the same time by another integrated circuit to detect angular movement of the animal. Both components are available as integrated circuits which can easily be placed on the same printed circuit board. By analysing acceleration as well as angular movement of the animal, more data can be stored in the memory and further analysis can be performed.

The system can be used for tracking leaps. By using an accelerometer, it is possible to detect all kinds of leap of the animal. Leap-activity can be an indication that could be very useful for a farmer.

The system can transmit and receive pulses at different time intervals. It is possible by means of this invention to transmit data very fast if necessary but in a situation where an animal has normal behaviour there is no reason for transmitting data several times per minutes. Instead data can be transmitted maybe one or two times per day but if an animal is under observation because the system has indicated abnormal behaviour, it is possible to transmit data very often.

The system can comprise calving detectors, which calving detectors communicate with the local processor. The system can also transmit calving alarms and in a situation where calving detectors are used, it is probably necessary to transmit the data very often in order to supply the farmer with the calving alarm information as soon as possible.

Detectors carried by the animal can detect acceleration for detecting normal or abnormal behaviour of animals, where communication can be performed by short-range radio communication for transmitting data from processors carried by the animal to a central processor.

By measuring acceleration of the animal and placing the data in an event log in a computer system carried by the animal this computer system will always comprise indication of the behaviour of the animal some hours backwards. If a farmer wishes further information about an animal, he can look at the event log in the central computer system where information is stored probably of the whole life of the animal. The new events can be transmitted to the central computer system if the farmer wishes to. Otherwise, data are transmitted with some intervals. These intervals can be changed if abnormal situations occur.

### BRIEF DESCRIPTION OF THE DRAWINGS

FIG. 1 shows a system according to the invention.

FIG. 2 shows an ear tag.

FIG. 3 shows a system for detecting the behaviour of animals

### DETAILED DESCRIPTION OF THE INVENTION

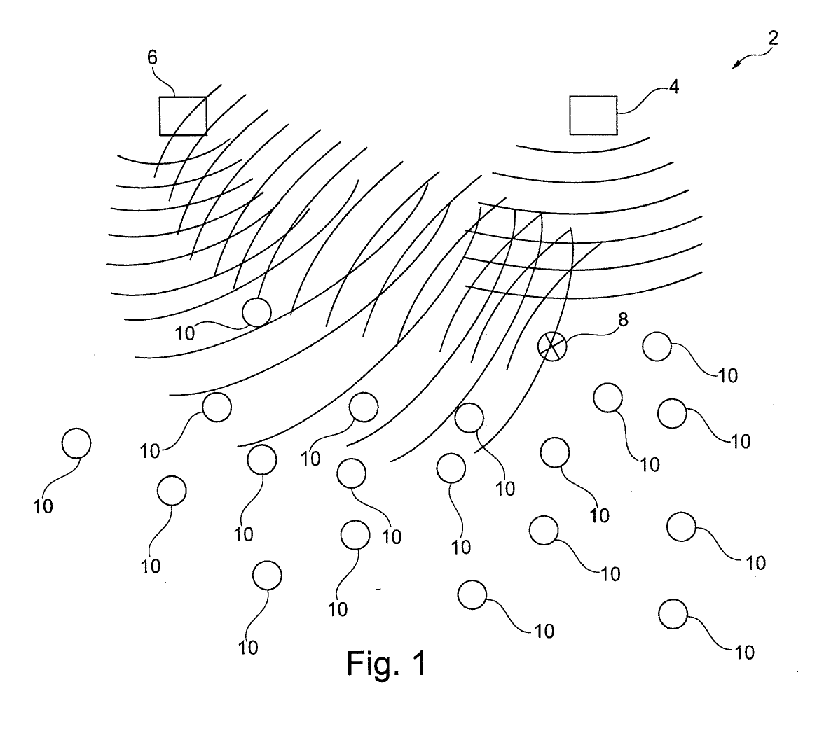

FIG. 1 shows a system 2 according to the invention, consisting of a first transceiver station 4, a second transceiver station 6 and an active unit in a movable object 8 and passive movable objects 10.

On Figure is shown a wave pattern arising when signals are transmitted from the transmitter stations 4 and 6. These transmitter stations transmit a coded signal which activates the transceiver system in the movable unit 8, which now transmits a response pulse. The wave front of this response pulse is also indicated. Thus it appears that the wave front reaches transceiver station 4 first, long before the signal reaches transceiver station 6. On the basis of the time difference or the phase difference existing between received signals, a reasonably accurate calculation of the position of the transceiver unit in the movable object 8 can be performed by means of a computer unit connected with the transceiver stations 4 and 6. This position determination may be performed with accuracy, of course if no unfavourable reflections of signals down to fractions of a wavelength occur. However, this system operates with so short wavelengths that a position determination within a wavelength is more than sufficient. Typically, great certainty may be achieved within a position of 10 cm. It is possible to use more transceivers and in this way a more accurate position can be received. By use of three or more receivers it is possible to detect positions in three dimensions, which by cattle can result in detection of leaps.

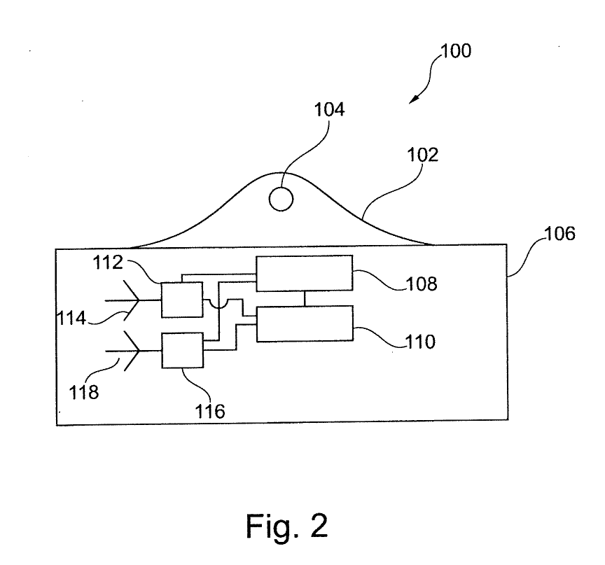

FIG. 2 shows an ear tag 100 having a bracket 101 with a rivet hole 104. Below is provided a housing 106 which contains a battery 108 communicating with a processor unit 110, where the processor unit interacts with a receiver unit 112 and a transmitter unit 116.

By means of a not shown rivet, the unit 100 may be provided on an ear of cattle by means of the hole 104. The receiver 112 which is connected with a receiver antenna 114 receives at time intervals signals which are transmitted to the processor unit 110. Only when the correct signal with a correct code is received by the receiver 112 the unit 110 is activated, which then transmits a code signal containing an identification code via the transmitter 116 connected with the transmitter antenna 118. The transmitted signal may then be received as shown on FIG. 1 by at least two different transceiver stations.

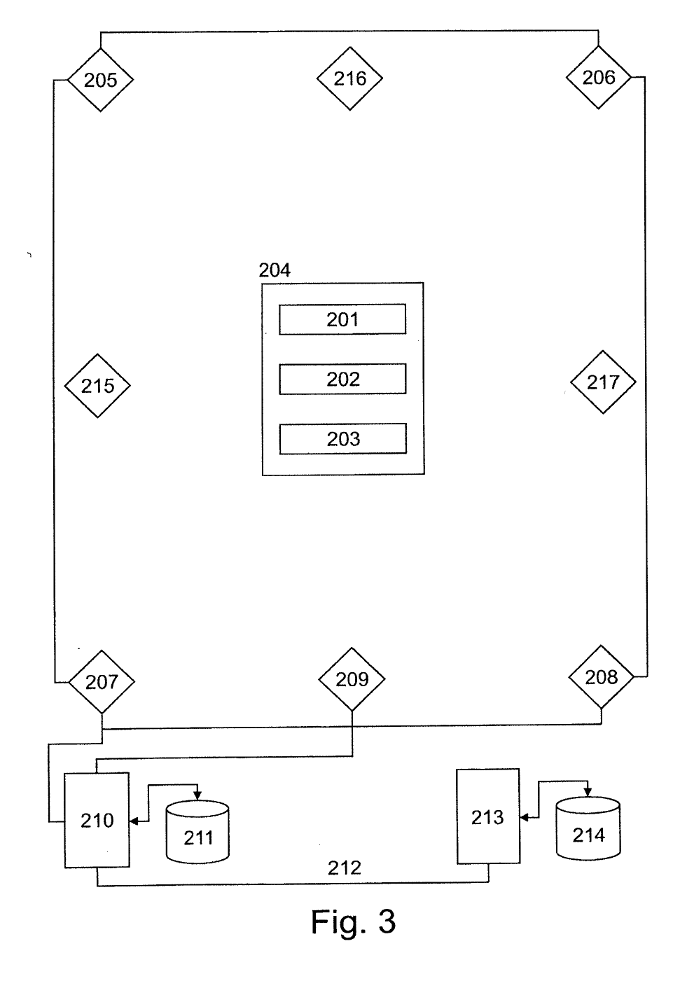

FIG. 3 shows a system for detecting the behaviour of animals. FIG. 3 shows a possible example of a stable or a field where a number of animals, e.g. cows are held. Position number 204 indicates a tag that has to be carried at each animal. This tag 204 comprises a mesh compatible network communication unit 201 and an accelerometer 202 for measuring three-dimensional acceleration and ultra wideband radio transmitter receiver 203.

Furthermore, at FIG. 3 ultra wideband sensors 205, 206, 207 and 208 are shown. These ultra wideband sensors 205, 206, 207 and 208 are here indicated in the corners of the stable or field. The FIG. 3 further shows a mesh compatible access point 209 which access point 209 is communication with a local processor 210. This processor is further connected to a local storage 211 for storing received data. The processor 210 is further connected by a net 212 to a back end processor 213 for calculating the behaviour of the animals. This back end processor 213 is further communicating to a back end storage 214 of behaviour and all calculations that are performed. Further, at the FIG. 3 is indicated mesh routers 215, 216 and 217.

In operation, a high number of tags 204 are placed on the animals e.g. in a stable. Each of these animals will then carry an accelerometer 202 that detects the movement of the animal and there will be two different communication systems in the tag so that e.g. the behaviour of the animal can be transmitted by a mesh compatible network 201 which e.g. could be a ZigBee network. Furthermore, the tag 204 comprises the ultra wideband receiver transmitter 203 which communicates with the ultra wideband sensors 205, 206, 207 and 208 which ultra wideband sensors are used for position detection of the animals. This detection of the position could be performed for one animal at a time because at first a signal comprising a code transmitted to each of the ultra wideband receiver transmitters 203 and afterwards the ultra wideband receiver transmitter 203 will transmit a short-coded message which is detected at the ultra wideband sensors 205, 206, 207 and 208. By measuring the receiving time or maybe a phase difference between the signals, it is possible to indicate the position of the tag 2044 very accurately. This process can then be repeated for all animals in a stable or in a field. Because the signals transmitted are very short, the position of each animal can be detected perhaps every minute even in a stable or in a field where hundreds of animals are held.

Further information is achieved by the accelerometer 202 and with further detectors placed in relation to the tag 204. These detectors could be e.g. pulse or temperature detectors. Also a calving alarm could be connected so that the data transmitted by the mesh compatible network 201 comprises a lot of different information. This information could in the beginning be stored just in the tag 204 which could comprise a memory. Data from that memory could be transmitted after time intervals or by request from the system over the mesh compatible network 201 which maybe is able to communicate with one of the mesh routers 215, 216 or 217 or directly to the mesh compatible access point 209. In some situations, the mesh compatible network 201 will communicate with the next tag 204 at another animal and from here further to another tag 204 until the data package is received at one of the mesh routers 15 to 17 or at the mesh compatible access point 209. All the transmitted data are then sent to the local processor 210 for storing at the local data storage 211. The received data are then further transmitted over the network 212 to the processor 213 which is a back end processor for calculation of animal behaviour. By analysing at the back end processor 213, it is possible to indicate deceases by comparing an actual pattern with patterns of other animals stored in the back end storage 213. In this way, the abnormal behaviour of an animal can be indicated days before other medical indicators can be found. On the basis of critical behaviour of an animal, the farmer starts further observation of the animal in question, e.g. the mesh compatible network 1 at the tag 4 carried by the animal can be coded to transmit data more often then usual. Then the farmer also knows by his routine of inspection in a stable or in a field that there are some animals which he have to observe very carefully because their behaviour have been critical up to the analysing time.

It is possible, e.g. in a stable, that one or more video cameras are placed e.g. at the ceiling to direct one or more cameras towards one selected animal and because of the position detection of the animals, it is possible to follow exactly that animal. In this way, it is possible to save a video sequence of an animal having an abnormal behaviour.

What is claimed is:

1-22. (canceled)

23. System for detection and position determination of movable objects, the objects each being provided with an electronic transceiver unit which by reception of a first signal emits a second signal, the second signal containing a unique information code related to a movable object, where the electronic transceiver units communicate with at least two fixed transceiver facilities connected with at least one computer, characterised in that communication between the fixed transceiver facilities and the electronic transceiver units occurs in a ultra wideband frequency spectrum in a frequency range from 3.10 GHz to 10.6 GHz, that communication occurs in the form of transient pulses emitted from the electronic transceiver units, and that position determination is performed by calculating time or phase difference between receptions of a signal at least two transceiver facilities, respectively.

24. System according to claim 23, characterised in that the system includes handheld transceiver units containing a computer, the computer communicating with at least one database with information related to the movable objects, and that the computer on the basis of received signals selects and presents data related to movable object or objects for a user.

25. System according to claim 23, characterised in that the movable objects are provided on a collar and such that the movable objects are disposed on top of the collar.

26. System according to claim 23, characterised in that transceiver stations are provided in a defined area.

27. System according to claim 23, characterised in that the system is used for tracking behaviour of moveable objects.

28. System according to claim 27, characterised in that position determination is performed in three different directions and such that position as well as horizontal and vertical position are determined.

29. System according to claim 28, characterised in that the system is used for tracking change in behaviour during oestrus.

30. System according to claim 29, characterised in that the system transmits and receives pulses at different time intervals.

31. System according to claim 30, characterized in that the system comprises at least one camera, which camera is carried by a 3D servo system, which servo system is controlled from the system, which system direct one or more cameras in the direction of a selected moving object.
